(19) United States
(12) Patent Application Publication
(10) Pub. No.: US 2022/0414164 A1
(43) Pub. Date: Dec. 29, 2022

(54) E-COMMERCE TOOLKIT INFRASTRUCTURE

(71) Applicant: Metacluster LT, UAB, Vilnius (LT)

(72) Inventors: Eivydas VILCINSKAS, Siauliai City (LT); Rimantas STANKEVICIUS, Vilnius (LT); Aleksandras SULZENKO, Vilnius (LT)

(73) Assignee: Metacluster LT, UAB, Vilnius (LT)

(21) Appl. No.: 17/360,587

(22) Filed: Jun. 28, 2021

(51) Int. Cl. G06F 16/951; G06F 16/955; G06F 16/25

(52) U.S. Cl. CPC G06F 16/951; G06F 16/9566; G06F 16/258; G06Q 30/0201

(57) ABSTRACT

In one aspect, methods and systems for producing an index of a target website are described. In another aspect, methods and systems for extracting specific information from one or more specific indexed URLs are described. The method and system for producing an index of a target website include receiving and analyzing a client's specifications for the index, accessing a target website, extracting the relevant information from the target website, parsing the extracted information in order to identify the URLs, producing the index containing the identified URLs, storing the index (which contains the list of indexed URLs) in a database, compiling the index (which contains the list of indexed URLs) into different formats requested by the client and providing the client, the access information for accessing the compiled index.

### FIELD

The disclosed embodiments generally relate to methods and systems for improving web scraping/gathering services. More particularly, the disclosed embodiments relate to a method and system that automatically identifies and scrapes related web pages of a web domain.

### BACKGROUND

Web scraping (also known as Internet scraping, website scraping, web data extraction, data harvesting) is an automated gathering of publicly available web data from specific websites. Web scraping aids in acquiring a plethora of web data rapidly and efficiently. Web scraping is usually accomplished by executing a program that automatically queries a web server and requests data, then parses the data to extract the requested information. In simple terms, web scraping provides a solution for clients seeking access to a vast amount of structured web data in an automated method.

Web scrapers, in a general sense, are computer programs. Web scrapers are capable of requesting and extracting data from target websites in an automated manner. Advanced web scraping tools are also capable of parsing the required data. Rather than accessing one page at a time, web scrapers can collect, process, aggregate and present large databases consisting of numerous pages at once. In simple terms, web scrapers aid in automating the onerous process of collecting and processing large amounts of data.

In general, a web scraping process can be classified into three primary steps: a) Sending a request to the targeted websites. Typically, web scraping tools will make HTTP requests, such as GET and POST, to the target websites to acquire the contents of a specific URL. b) Extracting required data. After receiving the request from a web scraper, the target web servers will return the data in HTML format. However, if the web scraping client needs to extract specific information from the HTML file, in that case, web scrapers will parse the data according to the client's requirements. c) Storing scraped data. This is the final step of the whole scraping process. Typically, the scraped data is stored in a database.

There are different types of web scrapers; mainly, web scrapers are classified based on their installation methods. Browser-extension-based scrapers, software-based scrapers and cloud-based scrapers are some of the few categories of web scrapers. Browser extension scrapers can be easily integrated and are one of the easy-to-use scraping tools. However, browser extension scrapers can scrape only one page at a time. Therefore, scraping a large amount of data using a browser extension scraper is not suitable. Software-based scrapers, like any other software, are installed and configured on a computer system. Software-based scrapers are ideal for scraping medium to large chunks of data. Unlike browser extension scrapers, software-based scrapers can scraper more than one web page at a time. Compared to other types of scrapers, cloud-based scrapers can gather vast amounts of data because cloud-based scrapers run on multiple computing environments that allow easy scaling. Unlike other scraping tools, cloud-based scrapers are one of the robust scraping solutions.

In networking, Hypertext Transfer Protocol (HTTP) is one of the application layer protocols designed to transfer information between network devices and runs on top of other layers of network protocol stack. A typical flow over HTTP involves a client device making a request to a server, which then sends a response message. An HTTP request carries with it a series of encoded data that carries different types of information. A typical HTTP request contains a) HTTP version type; b) a URL; c) an HTTP method; d) HTTP request headers; d) optional HTTP body. HTTP is a stateless protocol; that is, each command runs independently of any other command. Initially, HTTP requests each created and closed a TCP connection. However, in newer versions of the HTTP protocol, the persistent connection allows for multiple HTTP requests to pass over a persistent TCP connection or an UDP connection, improving resource consumption.

An HTTP method, (also known as HTTP verb) indicates the action that the HTTP request expects from the queried server. For example, two of the most common HTTP methods are ‘GET’ and POST′; a ‘GET’ request expects information back in return, while a ‘POST’ request indicates that the client is submitting information to the web server (such as information. E.g., a submitted username, password). Likewise, HTTP headers contain text information stored in key-value pairs and are included in every HTTP request (and response). These headers communicate main information such as for example, type of client's browser or information about the requested data. The body of an HTTP request is the part that contains the information that the request is transferring. Typically, the body of an HTTP request contains any information being submitted to the web server such as, for example, username and password or any other data entered on a form.

An HTTP response is what web clients (often browsers) receive from a web server as an answer to an HTTP request. These HTTP responses communicate valuable information based on what was requested in the corresponding HTTP request. A typical HTTP response contains a) an HTTP status code; b) HTTP response headers; c) optional HTTP body. HTTP status codes are three-digit codes most often used to indicate whether an HTTP request has been successfully completed. Much like an HTTP request, an HTTP response contains headers that convey important information such as the language and format of the data being sent in the response body. Successful HTTP responses to ‘GET’ requests generally contain a body that carries the requested information. In most web requests, this is the HTML file which a web browser will translate into a web page.

A website is a collection of web pages containing related contents identified by a common domain name and published on at least one web server. A domain name is a series of alphanumeric strings separated by periods, serving as an address for a computer network connection and identifying the owner of the address. Domain names consist of two main elements—the website's name and the domain extension (e.g., .com). Typically, websites are dedicated to a particular type of content or service. A website can contain hyperlinks to several web pages, enabling a visitor to navigate between web pages. Web pages are documents containing specific collections of resources that are displayed in a web browser. A web page's fundamental element is one or more text files written in Hypertext Markup Language (HTML). Each web page in a website is identified by a distinct URL (Uniform Resource Locator). There are many varieties of websites, each providing a particular type of content or service.

Websites can be arbitrarily classified in many ways; a few such classifications are static websites and dynamic websites. Static websites contain web pages with fixed content. Each web page of a static website is coded in HTML and displays the same information to every visitor. Static websites are the most basic type of websites and do not require any complex web programming. Unlike static websites, dynamic websites contain web pages that are generated in real-time. Web scripting codes support web pages in a dynamic website. When a web page of a dynamic website is accessed, the web page's code is parsed on the web server, and the resulting HTML is sent to the visitor's web browser. Most large websites are dynamic since dynamic websites are easier to maintain than static websites. As web pages of a static website each contain unique content, i.e., a static web page must be manually opened, edited, and published whenever a change is made. Dynamic pages, on the other hand, access information from a database.

In networking, the term URL stands for Uniform Resource Locator. A URL is nothing more than the address of a given unique resource on the web. In general, each valid URL points to a unique resource. Such resources can be an HTML page, a CSS document, an image, etc. In general, URLs are categorized into two main types—a) absolute URL; b) relative URL. An absolute URL contains all the information necessary to locate a web resource. In contrast, a relative URL typically consists only of the path to a web resource. That is, a relative URL locates a resource using an absolute URL as a starting point.

Typically, an URL is composed of different parts, some mandatory and other optional parts. The most important parts of an URL are a) Scheme—The first part of the URL; scheme indicates the protocol that the browser must use to request the resource. b) Authority—The second part of the URL is separated from the scheme by the character pattern ://. The authority part of the URL can contain both the domain name and the port number, separated by a colon. The port number indicates the technical ‘gate’ used to access the resources on the web server. c) Path to resource—The third part of the URL denotes the path to the resource on the web server. d) Parameters—The fourth part of the URL contains the parameters provided to the webserver. These parameters are a list of key/value pairs separated with the ‘&’ symbol. The web server can use the provided parameters to execute different operations before returning the requested resource. e) Anchor—The fifth part of the URL contains an anchor to another part of the resource. An anchor represents a sort of ‘bookmarked’ inside the resource, giving the browser the directions to display the content located at that ‘bookmarked’ spot.

Hyperlinks, usually called links, are a foundational concept behind the World Wide Web (WWW). Links can correlate any text string with a URL, such that a website's visitor can instantly reach the target document by clicking the link. Links are distinguished from the surrounding texts by being underlined in a different colour. Hyperlinks can be generally divided into two categories: internal and external hyperlinks. An internal hyperlink is a link between two webpages, where both webpages belong to the same website. In contrast, an external hyperlink is a link between two web pages of different websites. External hyperlinks can be classified either as an outbound or an incoming hyperlink.

Typically, Internal hyperlinks are usually organized in a link structure. The purpose of the internal hyperlink is to provide navigation through several web pages of a website in a particular manner known as a click path. A link structure usually consists of four standard forms: linear, tree, star and network, with each one having varying click path controls.

Within a linear link structure, web pages of a website are linked so that a predefined click path is created. Visitors to the websites with a linear link structure will navigate through several web pages in the order determined by the website operator. Conversely, if the internal linking follows a tree structure, the web pages of a website will be arranged in different hierarchy levels. For instance, a visitor will be accessing a landing page that has been optimized for search engines and then the visitor can click and navigate to a preferred category or a product page. The thematic orientation of the web pages (category, subcategory, product, article) is usually more specific when a visitor is further into the website's hierarchy level.

With a star link structure, a web page can contain several links to other similar web pages within the same website. On each web page, visitors can find hyperlinks to other relevant web pages in which additional information is provided about the linked items. Network-shaped link structures are characterized by the fact that almost all web pages of a website are on every web page. A website visitor will have the possibility of reaching the desired web page of the website from any point on the website. It is important to note that the link structure described above is at an abstract level. Practically, website operators can employ a mixture of internal links combined with several link strategies. For example, a website can follow the tree structure and at the same time offers network link structure via navigation menus, sidebars, and footers.

Web scraping is constantly changing because of new technologies and data-gathering processes. However, scraping vast amounts of data from certain types of websites can be challenging. Scraping data on a large scale from several leading e-commerce websites can be a complicated task. Gathering and maintaining vast amounts of data requires innovative resources and technologies. For instance, extracting data automatically from several web pages of an e-commerce domain is relatively unfeasible. Such a web scraping task requires the scraping client to provide URLs to every web page to be scrapped. Collecting and providing several URLs can be time and resource-intensive from a client's perspective.

Current web scraping solutions do not offer solutions for automatically identifying and scraping related web pages of a website/domain. Therefore, present embodiments detailed herein provide exemplary methods and systems to enhance the web scraping process, especially scraping e-commerce websites. In one aspect, the current embodiment provides methods and systems to automatically identify and scrape the related web pages of an e-commerce website.

### SUMMARY

The summary provided herein presents a primary or a general understanding of various aspects of exemplary embodiments disclosed in the detailed description accompanied by drawings. Moreover, this summary is not intended, however, as an extensive or exhaustive overview. Instead, the only purpose of this summary is to present the condensed concepts related to the exemplary embodiments in a simplified form as a prelude to the detailed description.

Embodiments of a method and system for producing an index of a target website are described. An index can include one or more specific URLs related to a target website. For example, an index may include URLs of every product web page from an e-commerce website. The method and system for producing an index of a target website include receiving and analyzing a client's specifications for the index, accessing a target website, extracting the relevant information from the target website, parsing the extracted information in order to identify the URLs, producing the index containing the identified URLs, storing the index (which contains the list of indexed URLs) in a database, compiling the index (which contains the list of indexed URLs) into different formats requested by the client and providing the client, the access information for accessing the compiled index.

Embodiments of a method and system for extracting specific information from one or more specific indexed URLs are described. The method and the system for extracting specific information from one or more specific indexed URLs include fetching the index containing the identified URLs from a message platform, instructing a data extracting module to extract information from multiple web pages belonging to the URLs present in the index, accessing the multiple web pages and extracting the information, parsing the extracted information in order to extract the specific information, storing the parsed information in a database, compiling the parsed information into formats requested by the client and providing the client, the access information for accessing the compiled parsed information.

### DESCRIPTION OF DIAGRAMS

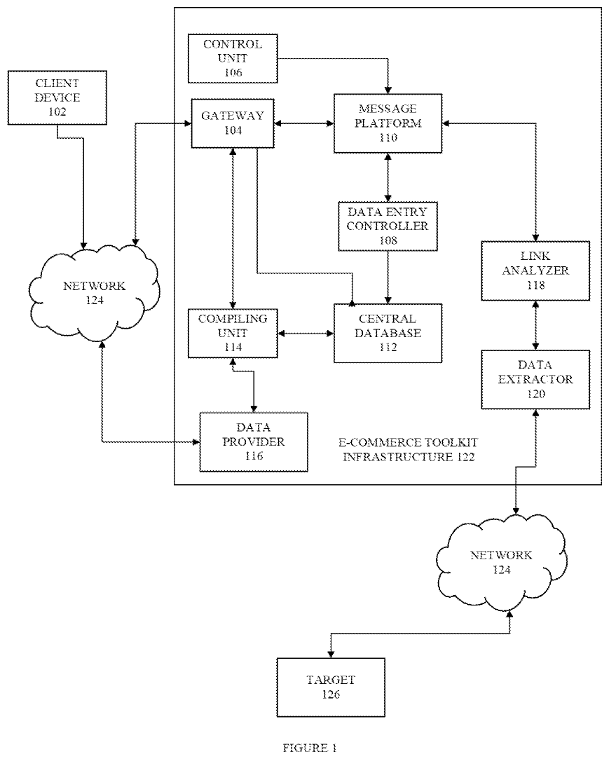

FIG. 1 is a block diagram illustrating an exemplary architectural depiction of various components of the embodiments.

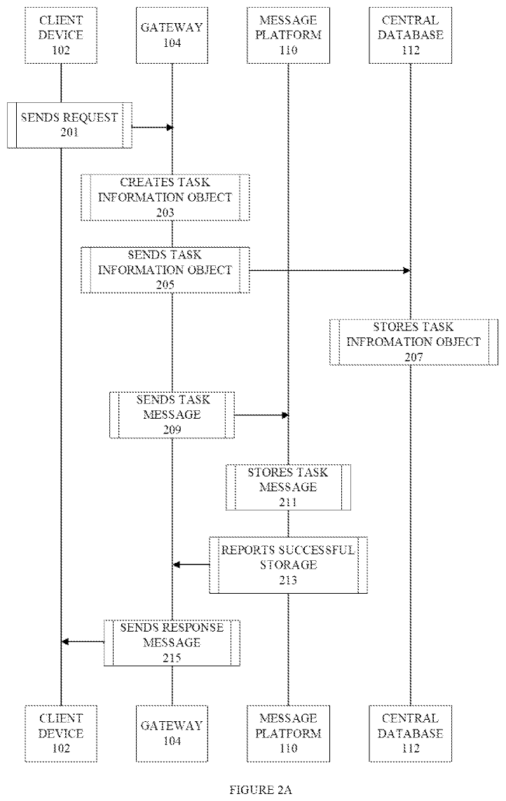

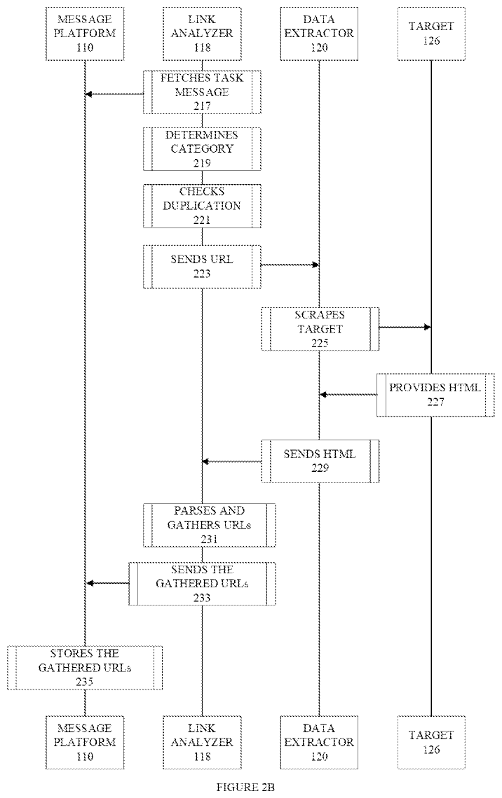

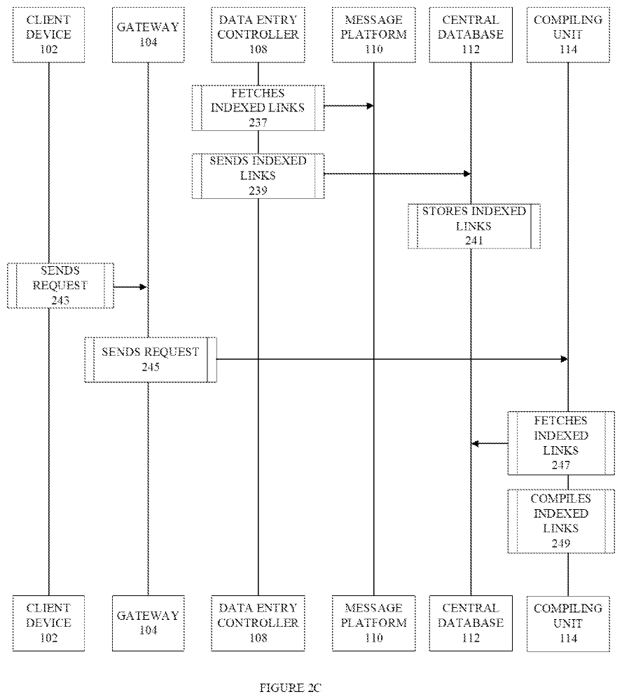

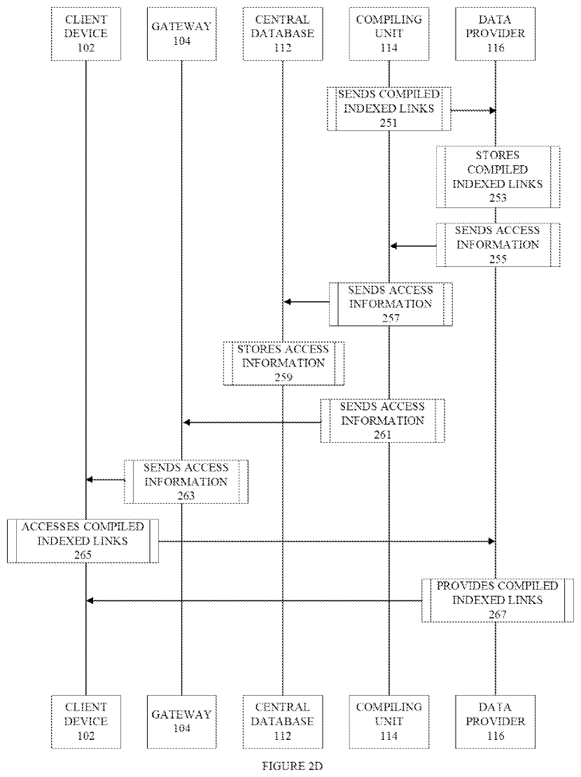

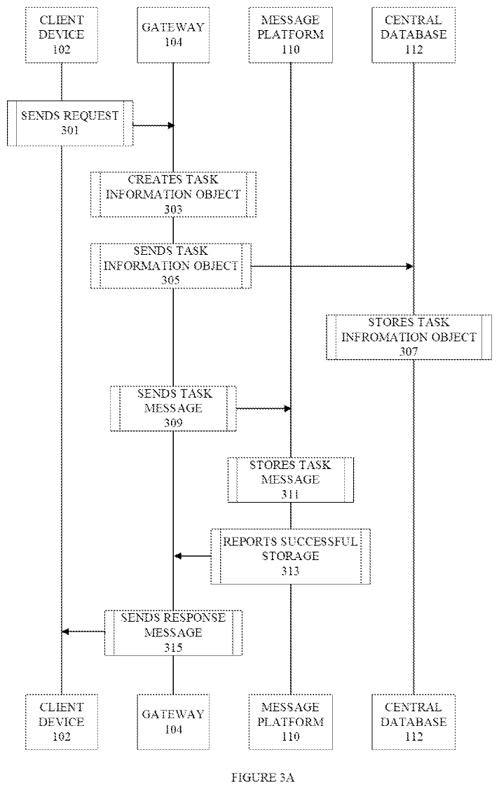

FIG. 2A through 2D is an exemplary flow diagram showing the process for generating an index of the target website according to one of the embodiments.

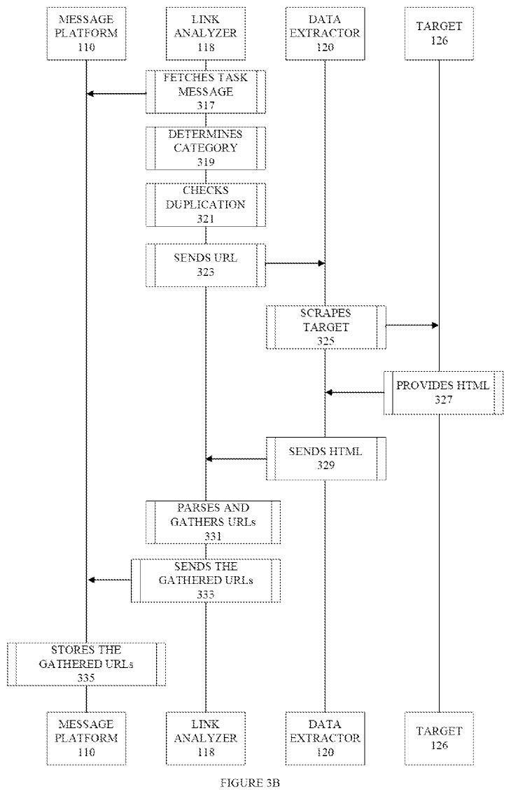

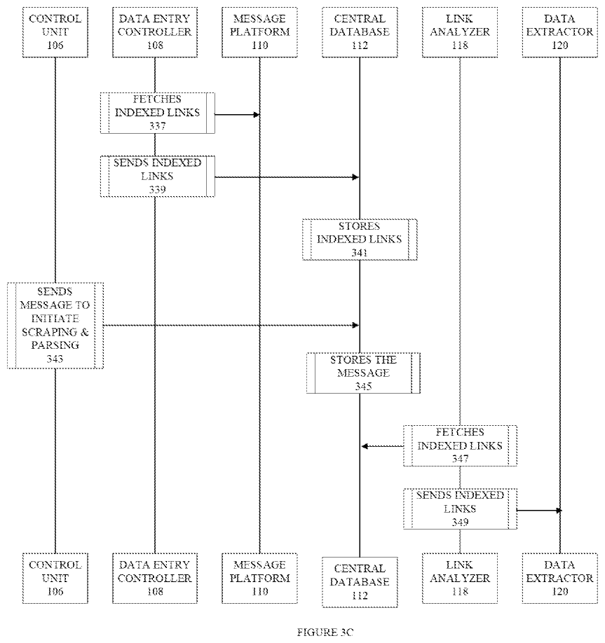

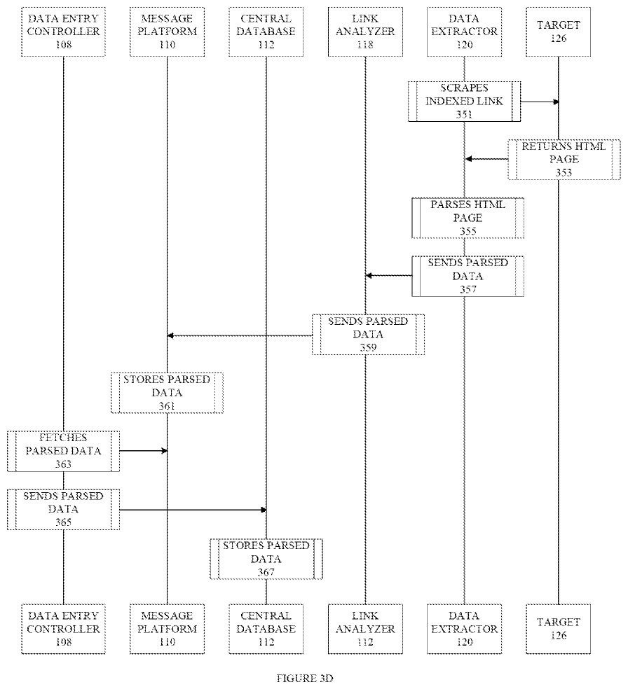

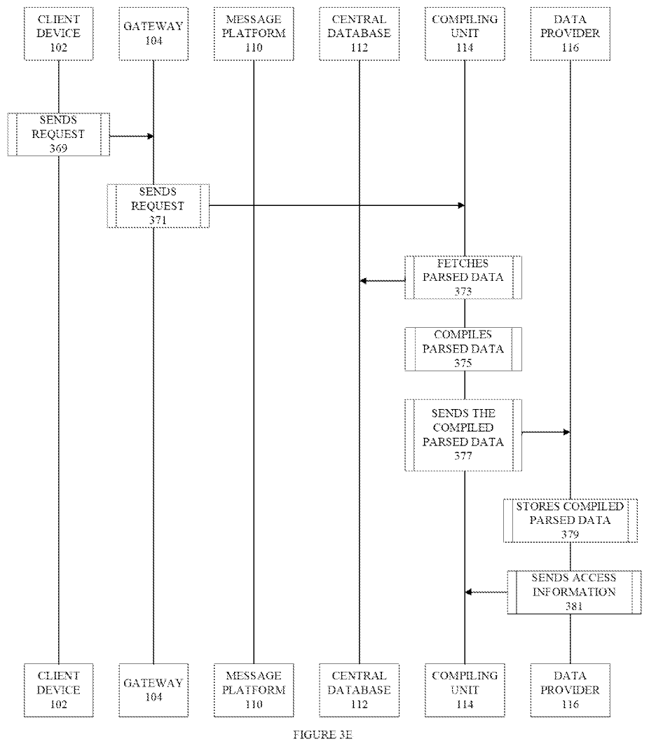

FIG. 3A through 3F is an exemplary flow diagram showing the process for generating an index of the target website and extracting data from the indexed links according to one of the embodiments.

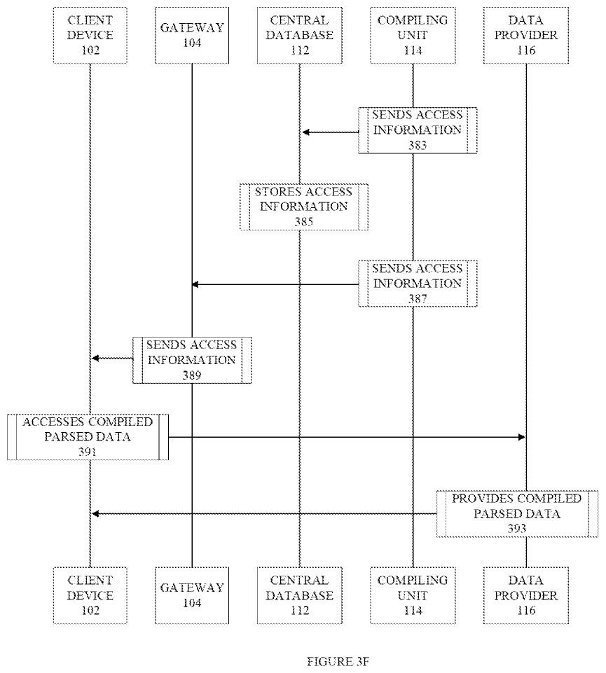

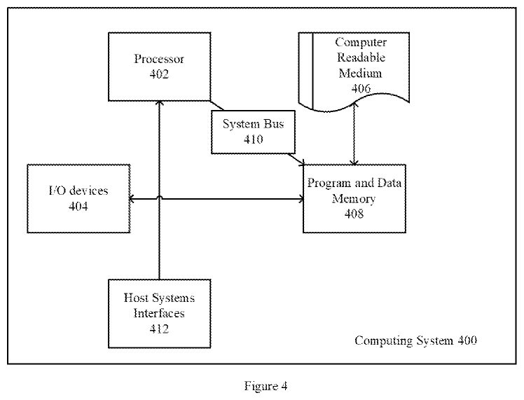

FIG. 4 shows a block diagram of an exemplary computing system.

### DETAILED DESCRIPTION

There are several problems associated with web scraping. Scraping data on a large scale from several websites can be a complicated task. Gathering and maintaining vast amounts of data requires innovative resources and technologies. For instance, extracting data automatically from several web pages of an e-commerce domain is relatively unfeasible. Such a web scraping task requires the scraping client to provide URLs to every web page to be scrapped. Gathering and providing several URLs can be time and resource-intensive from a client's perspective.

The current embodiments aim to reduce the resource and time that an average web scraping client spends on gathering and preparing a list of URLs necessary for executing web scraping operations. The current embodiments aid web scraping clients in gathering and preparing a list of URLs associated with a target website. For instance, a web scraping client needs to scrape every product page on an e-commerce website. However, the web scraping client may not necessarily possess the resources and the time required to gather every product page's URL present on the target website. Therefore, the current embodiments provide exemplary methods and systems for gathering and preparing a list of URLs associated with a target website. With the implementation of the current embodiments, the web scraping client now is required to provide only an initial URL to a target website. Identifying, gathering and preparing a list of URLs associated with the target website will be automatically executed by the current embodiments. Moreover, the current embodiments provide exemplary methods and systems to scrape web contents from several web pages addressed by the URLs associated with a target website.

A detailed description of one or more embodiments is provided below, along with the accompanying figures that show the steps involved in the described embodiments. Numerous specific details are provided in the following description in order to provide a thorough understanding of the described embodiments, which may be implemented according to the claims without some or all of these specific details.

Some general terminology descriptions may be helpful and are included herein for convenience and are intended to be interpreted in the broadest possible interpretation.

Client Device 102—a client device can be any suitable computing device including, but not limited to, a smartphone, a tablet computing device, a personal computing device, a laptop computing device, a gaming device, a vehicle infotainment device, a smart appliance (e.g., smart television or smart refrigerator), a cloud server, a mainframe, a notebook, a desktop, a workstation, a mobile device or any other electronic computing device used for making data extraction request. Additionally, it should be noted that the term “client” is being used in the interest of brevity and may refer to any of a variety of entities that may be associated with a subscriber account such as, for example, a person, an organization, an organizational role within an organization and/or a group within an organization.

Gateway 104—a processing unit; a constituent of the E-Commerce Toolkit Infrastructure 122. Gateway 104 can receive requests from Client Device 102 and can send back responses to Client Device 102 via Network 124. Gateway 104 can include an API (Application Programming Interface), a set of programming codes that enables Gateway 104 to exchange information with Client Device 104 and other components of the E-Commerce Toolkit Infrastructure 122. Specifically, Gateway 104 can communicate with Message Platform 110, Central Database 112 and Compiling Unit 114.

Control Unit 106—computing and a processing unit that coordinates and monitors the functioning of several components present within the E-Commerce Toolkit Infrastructure 122. Particularly, Control Unit 106 can access the Message Platform 110 to monitor and send messages of instruction to other constituents of E-Commerce Toolkit Infrastructure 122. Control Unit 104 can monitor the progress of every task message that is assigned to Link Analyzer 118. Control Unit 106 is a constituent of the E-Commerce Toolkit Infrastructure 122.

Data Entry Controller 108— a constituent of the E-Commerce Toolkit Infrastructure 122. Data Entry Controller 108 fetches the indexed links from Message Platform 110 and sends the indexed links to Central Database 112 for further storage.

Message Platform 110— a constituent of the E-Commerce Toolkit Infrastructure 122 and is responsible for storing and providing information to other constituents of the E-Commerce Toolkit Infrastructure 122. Message Platform 110 can function as an intermediary between the constituents of the E-Commerce Toolkit Infrastructure 122 in exchanging vital information such as for example task messages, gathered URLs, indexed URLs. Message Platform 110 can include several internal sections where information is received and stored. Specifically, Gateway 104, Link Analyzer 118 and Data Entry Controller 108 can either send information to Message Platform 110 for storage or access the Message Platform 110 to obtain information for executing specific processes. Control Unit 106 has continuous access and visibility into all of the internal divisions of the Message Platform 110 in order to monitor the tasks' progress.

Central Database 112—a storage unit and a constituent of the E-Commerce Toolkit Infrastructure 122. Central Database 112 can store information but is not limited to a task information object, indexed links, parsed data, and access information.

Compiling Unit 114—a constituent of the E-Commerce Toolkit Infrastructure 122; Compiling Unit 114 is responsible for compiling the indexed links and the parsed data into different formats. Compiling Unit 114 can receive and send information to Gateway 104. Compiling Unit 114 can access the Central Database 112 to obtain the indexed links and the parsed data to execute the compiling process. After performing the compiling process, Compiling Unit 114 can send the compiled information to Data Provider 116. Further, Compiling Unit 114 can receive the access information from the Data Provider 116 and can send the access information to Central Database 112 for storage. The access information can include links/URL for Client Device 102 to directly access and download the compiled indexed links.

Data Provider 116—a constituent of the E-Commerce Toolkit Infrastructure 122 where the compiled indexed links and passed data are stored for the Client Device 102 to access. Data Provider 116 can receive the compiled indexed links and passed data from Compiling Unit 114, and in return, Data Provider 116 can send the access information to Compiling Unit 114. The access information can include links/URLs that enables Client Device 102 to access and obtain the necessary compiled information, i.e., the compiled indexed links or parsed data or, in some instances, both.

Link Analyzer 118—computing and a processing unit; also a constituent of the E-Commerce Toolkit Infrastructure 122. Link Analyzer 118 is responsible for executing several complex processes such as fetching the task messages from Message Platform 110, sending the start URL to Data Extractor 120, receiving the scraped HTML page from Data Extractor 120, parsing the HTML page, gathering the links from HTML page, categorizing the gathered links, checking for duplication among the gathered links and sending the indexed and indexable links to Message Platform 110. The processes mentioned above are some of the essential processes executed by Link Analyzer 118; however, further in the detailed description, one will recognize the several other complex processes executed by Link Analyzer 118.

Data Extractor 120—a constituent of E-Commerce Toolkit Infrastructure 122 responsible for scraping a target URL. Data Extractor 120 can receive a target URL from Link Analyzer 118 to execute the scraping process. Data Extractor 120 scrapes a target, obtains the target's HTML page, and sends the HTML page to Link Analyzer 118.

E-Commerce Toolkit Infrastructure 122—a party providing several data retrieval services to a client. Some of the exemplary data retrieval services provided by E-Commerce Toolkit Infrastructure 122 are: a) generating an index for a target website; b) extracting specific data from web pages belonging to each individual indexed URLs listed in the index.

Network 124—a digital telecommunications network that allows nodes to share and access resources. Examples of a network: local-area networks (LANs), wide-area networks (WANs), campus-area networks (CANs), metropolitan-area networks (MANs), home-area networks (HANs), Intranet, Extranet, Internetwork, Internet. In the current disclosure, the Internet is the most relevant Network for the functioning of the method.

Target 126—an exemplary instance of a web server serving any media content, resources, information, and services over the Internet or other networks. In the disclosed embodiments, Target 126 is also referred to as target website and/or target. Target 126 can be, for example, a domain name and/or a hostname, possibly with a defined network protocol port, that represents a resource address at a remote system serving the content accessible through industry-standard protocols. Target may be a physical or a cloud server that contains the content requested through the target address.

In one aspect, the present embodiments include a system and a method for producing an index of a target website. Those of ordinary skill in the art will realize that the following detailed description of the present embodiments is illustrative only and is not intended to be in any way limiting. Other embodiments of the present system(s) and method(s) will readily suggest themselves to such skilled persons having the benefit of this disclosure. Reference will now be made in detail to implementations of the present embodiments as illustrated in the accompanying drawings. The same reference indicators will be used throughout the drawings and the following detailed description to refer to the same or like parts.

FIG. 1 is a block diagram illustrating an exemplary architectural depiction of various components of the disclosed embodiments. FIG. 1 comprises Client Device 102, E-Commerce Toolkit Infrastructure 122, Network 124 and Target 126. E-Commerce Toolkit Infrastructure 122 comprises Gateway 104, Control Unit 106, Data Entry Controller 108, Message Platform 110, Central Database 112, Compiling Unit 114, Data Provider 116, Link Analyzer 118 and Data Extractor 120. In FIG. 1, Network 124 can be local-area networks (LANs), wide-area networks (WANs), campus-area networks (CANs), metropolitan-area networks (MANs), home-area networks (HANs), Intranet, Extranet, Internetwork, Internet. In the current disclosure, the Internet is the most relevant network for the functioning of the embodiments. Connection to Network 124 may require that the Client Device 102, E-Commerce Toolkit Infrastructure 122, and Target 126 execute software routines that enable, for example, the seven layers of the OSI model of the telecommunication network or an equivalent in a wireless telecommunication network.

While the elements shown in FIG. 1 implement an exemplary embodiment, in practice, and as recognized by a person skilled in the art, some components shown in FIG. 1 can have different titles or can be combined into a single component instead of two separate component (for example, Control Unit 106, Gateway 104 and, Data Entry Controller 108 can be co-located as a single element. Likewise, Link Analyzer 118 and Data Extractor 120 can be combined as a single element.) However, the functionality of components and the flow of information between the components is not impacted generally by such combinations or consolidations. Therefore, FIG. 1, as shown, should be interpreted as exemplary only and not restrictive or exclusionary of other features, including features discussed in other areas of this disclosure. Furthermore, in practical implementations, E-Commerce Toolkit Infrastructure 122 can comprise multiple Link Analyzers 120, Message Platforms 112, Targets 128, Client Devices 102. However, in the current disclosure, E-Commerce Toolkit Infrastructure 122 comprises a single instance of Link Analyzer 118, Message Platform 110, Target 126, Client Device 102.

In operation, Client Device 102 establishes communications with Gateway 104 via Network 124 as per standard network communication protocols, e.g., HTTP, HTTPS. A network communication protocol provides a system of rules that enables two or more entities in a network to exchange information. The protocols define rules, syntaxes, semantics, synchronization of communication and possible error recovery methods. After establishing the communication, Client Device 102 sends a request for generating an index of a target website. Here, an index of a website refers to a list of indexed links/URLs that matches the index parameters provided by Client Device 102. For example, Client Device 102 may send a request for generating an index of an e-commerce website containing the links to every product web page available on the particular e-commerce website.

However, before sending the actual request for generating an index of the target website, Client Device 102 may send authentication credentials to Gateway 104 for authentication and authorization. Gateway 104 receives the authentication credentials sent by Client Device 102 and authorizes Client Device 102. In the current embodiment, authentication of the Client Device 102 can be executed through standard authentication protocols and formats, e.g., JSON web token (JWT). Authentication credentials can include but are not limited to client identification (client ID), passwords, serial numbers, PINs, hash identifications (hash ID).

After successful authentication, Client Device 102 sends the request for generating an index of the target website, which, in the current embodiment, is represented by Target 126. Client Device 102 can include multiple information within the request for generating an index of Target 126. Some of the exemplary information included in the request for generating an index of Target 126 are start URL, index parameters, information regarding the type of data retrieval service. Here, Start URL is the URL to the target website. Index parameters can include information or computer programming expressions signifying the parameters for determining which type of links/URLs must be identified as indexable, indexed or excluded links. For example, Client Device 102 may request to generate an index consisting of a list of links/URLs of every product page belonging to an e-commerce website. Link/URL to a product web page on a particular e-commerce website is an indexed link, whereas a link/URL to a web page that might include a link/URL to a product page is an indexable link. Other links/URLs that lead to irrelevant web pages (e.g., homepage or other non-product web pages) are excluded links. In the current disclosure, the term link and URL are used interchangeably and refers to a web address of a unique resource on the World Wide Web (WWW). Information regarding the type of data retrieval service can include information regarding the type or, in other words, the end goal of the data retrieval service. In the current embodiment, the type or the end goal of the data retrieval service is to generate an index of a target website.

After receiving the request for generating an index of the target website, Gateway 104 creates a task information object. Also, Gateway 104 generates a task identification (task ID) for the respective request received from Client Device 102. Task ID can include but not limited to a randomly generated 64-bit integer, increasing monotonically. The task information object created by Gateway 102 can include but is not limited to task ID, client ID, task status, start URL, index parameters, timestamps. Timestamps can refer to but are not limited to task creation timestamps and last updated timestamps. Following the creation of the task information object, Gateway 104 sends the task information object to Central Database 112. Accordingly, Central Database 112 receives and stores the task information object.

Next, Gateway 104 creates and sends a task message to Message Platform 110. The task message created and sent to Message Platform 110 can include but are not limited to task ID, index parameters, start URL. Message Platform 110 receives and stores the task message within Message Platform's 112 internal sections. After successfully storing the task message, Message Platform 110 reports back the successful storage of the task message to Gateway 104. Consequently, Gateway 104 sends a response message to Client Device 102, signifying the successful creation and storage of the task message. The response message sent by Gateway 104 to Client Device 102 can include but are not limited to client ID, timestamps, task ID, index parameters, start URL. Client Device 102 receives the response message from Gateway 104, and subsequently, the request/response cycle between Client Device 102 and Gateway 104 is terminated.

Once the task message is stored in the Message Platform 110, Link Analyzer 118 accesses and fetches the stored task message from Message Platform 110. After fetching the stored task message, Link Analyzer 118 analyzes and determines the category of the start URL present in the task message. Link Analyzer 118 determines the category of the start URL according to the index parameters. One must recall that the index parameter is included in the task message fetched from Message Platform 110. The index parameters include information or computer programming expressions signifying the parameters for determining the category of links/URLs. The categories are indexable, indexed or excluded links. Therefore, based on the index parameters, Link Analyzer 118 determines the category of the start URL as an indexable link.

After determining the category of the start URL, Link analyzer 118 checks the start URL against a list of URLs present in a duplication list. The duplication list contains URLs to web pages and/or target websites previously identified or processed by Link Analyzer 118. If the start URL matches with a URL from the duplication list, in such instances, the start URL will be considered as a duplicate link, and such duplicate links will be abandoned by Link Analyzer 118. However, if the start URL does not match any of the URLs from the duplication list, Link Analyzer sends the start URL to Data Extractor 120. Upon receiving the start URL from Link Analyzer 118, Data Extractor 120 begins the scraping process by accessing the target website (Target 126). The scraping process completes when Target 126 sends the HTML page to Data Extractor 120.

Consecutively, Data Extractor 120 sends the scraped HTML page to Link Analyzer 118. After which, Link Analyzer 118 parses the HTML page and gathers the URLs present within the scraped HTML page. Following the parsing and gathering of URLs, Link Analyzer 118 sends the gathered URLs to Message Platform 110 along with the respective task ID as an identity marker. Message Platform 118 receives and stores the gathered URLs within an internal section of the Message Platform 110. Subsequently, the scraped HTML page is stored in a cache by Link analyzer 118; here, cache can be internally available within the Link Analyzer 118 or an external service.

Link Analyzer 118, in the following steps, fetches one of the gathered URLs from Message Platform 110. After fetching one of the gathered URLs, Link Analyzer 118 determines the category of the particular gathered URL according to the index parameters. The index parameters include information or computer programming expressions signifying the parameters for determining the category of links/URLs. The categories are indexable, indexed or excluded links. Therefore, Link Analyzer 118 determines the category of the gathered URL as either an indexable or indexed or excluded link.

An excluded link (i.e., a gathered URL that is determined as an excluded link) is abandoned by Link analyzer 118. In contrast, an indexable or indexed link (i.e., a gathered URL that is determined as either an indexable or indexed link) is checked for duplication. Specifically, Link Analyzer 118 checks the indexable or indexed link against the duplication list. The indexable or indexed link that matches one of the URLs from the duplication list is considered a duplicate link. Link Analyzer 118 abandons such a duplicate link. After checking for duplication, Link Analyzer 118 sends the indexed link to Message Platform 118 for storage. Message Platform 118 receives and stores the indexed link from Link Analyzer 118 within an internal section of the Message Platform 118. However, Link Analyzer 118 sends the indexable link to Data extractor 120. Data Extractor 120 receives the indexable link and repeats the process of scraping. After scraping the indexable link, Data Extract 120 sends the HTML page of the indexed link to Link Analyzer 118. After which, Link Analyzer 118 parses and gathers URLs present within the scraped HTML page. Link analyzer 118 sends the gathered URLs to Message Platform 110 for storage. Accordingly, Message Platform 110 receives and stores the gathered URLs within an internal section of the Message Platform 110.

Thus, Link Analyzer 118 repeats the process of fetching the gathered URLs from Message Platform 110, determining the categories of the gathered URLs, checking for duplicates, sending the indexed links to Message Platform 110, and/or sending the indexable links to Data Extractor 120 for executing scraping process, parsing and gathering the URLs from the scraped HTML page and finally, sending the gathered URLs to Message Platform 110. Link Analyzer 118 recursively repeats the above-described processes till every gathered URL stored in Message Platform 110 is processed. However, in some embodiments, Link Analyzer 118 repeats the above-described processes till a specific duration of time has passed since the fetching of the task message and/or a specific number of indexed URLs are stored in Message Platform 110 and/or a specific number of parsing operation has been executed and/or a request from Client Device 102 to terminate the process. Here, one must understand that the specific duration of time, the specific number of indexed URLs, and the specific number of parsing operations are either decided by E-Commerce Toolkit Infrastructure 122 or Client Device 102.

After Link Analyzer 118 processes every gathered URL, Data Entry Controller 108 fetches the indexed links (i.e., a gathered URL that is determined as an excluded link) from Message Platform 110. Subsequently, Data Entry Controller 108 sends the indexed links and the respective task ID to Central Database 112 for storage. Accordingly, Central Database 112 receives and stores the indexed links.

Subsequently, Client Device 102, sends a request to obtain the index of the target website (Target 126). However, before sending the actual request to obtain the index of the target website (Target 126), Client Device 102 may send authentication credentials to Gateway 104 for authentication and authorization. Gateway 104 receives the authentication credentials sent by Client Device 102 and authorizes Client Device 102. In the current embodiment, authentication of the Client Device 102 can be executed through standard authentication protocols and formats, e.g., JSON web token (JWT). Authentication credentials can include but are not limited to client identification (Client ID), passwords, serial numbers, PINs, hash identifications (hash ID).

Following authentication and authorization, Gateway 104 receives the request to obtain the index of the target website (Target 126) from Client Device 102. As part of the request to obtain the index of the target website (Target 126), Client Device 102 can include multiple information within the request. Some of the exemplary information included in the request to obtain the index of the target website (Target 126) are client ID, timestamps, task ID, index parameters, start URL, index format parameter. The term index format parameter includes information about the necessary format in which the index of the target website (Target 126) must be provided.

Subsequently, after receiving the request from Client Device 102, Gateway 104 requests Compiling Unit 114 to provide the index of the target website (Target 126). The request sent by Gateway 104 can include but is not limited to task ID, index format, client ID. Compiling Unit 114 receives the request to provide the index of the target website (Target 126) from Gateway 104 and accesses the Central Database 112. Specifically, Compiling Unit 114 identifies the indexed links with the received task ID. After which, Compiling Unit 114 fetches the indexed links and compiles the indexed links into the necessary format specified in the index format parameter. Some exemplary formats in which Compiling Unit 114 compiles the indexed links are CSV (comma separated values), JSON, JSONL, SQL database dump, and compressed collection files.

Compiling Unit 114 compiles and sends the indexed links to Data Provider 116. Data Provider 116 stores the compiled indexed links and, in return, sends access information. The access information sent by Data Provider 116 can include links/URL for Client Device 102 to directly access and download the compiled indexed links. Firstly, after receiving the access information from Data Provider 116, Compiling Unit 114 sends the access information to Central Database 112 for storage. Specifically, Central Database 112 receives and stores the access information in the associated task information object. Secondly, Compiling Unit 114 sends the access information to Gateway 104. Gateway 104 receives the access information from Compiling Unit 114 and sends the access information to Client Device 102.

Upon receiving the access information from Gateway 104, Client Device 102 accesses the compiled indexed links stored in Data Provider 116 and downloads the compiled indexed links. Specifically, Client Device 102 accesses the compiled indexed links via the link/URL included in the access information. One must recall that an index of a target website is a list of indexed links/URLs that matches the index parameters provided by Client Device 102. Thus, through the above-described embodiment, Client Device 102 can request and obtain an index of a target website according to specific index parameters.

In another embodiment, in FIG. 1, Client Device 102 sends a request to generate an index of a target website and extract data from the indexed links to Gateway 104. In such a case, E-commerce Toolkit 124 proceeds by generating the index of the target website according to the index parameters provided by Client Device 102 and, followed by scraping and parsing the web pages belonging to the indexed links present in the generated index. The process of generating an index is identical to the embodiment described previously.

After Data Entry Controller 108 fetches the indexed links from Message Platform 110 and sends the indexed links to Central Database 112, Control Unit 106 sends a message to initiate the process of scraping and parsing to Message Platform 110. Immediately after Message Platform 110 stores the message to initiate scraping and parsing, Link Analyzer 118 fetches the indexed links from Message Platform 110 and initiates scraping and parsing each indexed link. Specifically, Link Analyzer 118 sends an indexed link to Data Extractor 120, which scrapes and parses the particular indexed link. Similarly, every indexed link is scraped and parsed by Data Extractor 120 and sends the parsed data to Link Analyzer 118. Data Extractor 120 can parse the scraped data for any specific data/information, for example, product prices.

Link Analyzer 118 sends every parsed data belonging to each indexed link to Message Platform 110 to be stored within an internal section of the Message Platform 110. It must be understood that Link Analyzer 118 sends the parsed data belonging to each indexed link along with the respective task ID as an identity marker. Accordingly, Message Platform 110 receives and stores the parsed data within an internal section of the mEssage Platform 110. Once every parsed data has been stored in Message Platform 110, Data Entry Controller 108 the parsed data from Message Platform 110. Data Entry Controller 108 fetches the parsed data from Message Platform 110 and sends the parsed data to Central Database 112 for storage. After which, the remaining process of compiling and providing the parsed data to Client Device 102 is similar to the process described in the previous embodiment.

FIG. 2A is an exemplary flow diagram showing the process for generating an index of the target website. In step 201, Client Device 102 sends a request for generating an index of a target website. The term index refers to a list of indexed links/URLs that matches the index parameters provided by Client Device 102. For example, Client Device 102 may send a request for generating an index of an e-commerce website containing the links to every product web page available on the particular e-commerce website. In the current embodiment the target website is represented by the element Target 126.

Client Device 102 can include multiple information within the request for generating an index of Target 126. Some of the exemplary information included in the request for generating an index of Target 126 are start URL, index parameters, information regarding the type of data retrieval service. Here, Start URL is the URL to the target website. Index parameters can include information or computer programming expressions signifying the parameters for determining which type of links/URLs must be identified as indexable, indexed or excluded links. For example, Client Device 102 may request to generate an index consisting of a list of links/URLs of every product page belonging to an e-commerce website. Link/URL to a product web page on a particular e-commerce website is an indexed link, whereas a link/URL to a web page that might include a link/URL to a product page is an indexable link. Other links/URLs that lead to irrelevant web pages (e.g., homepage or other non-product web pages) are excluded links. In the current disclosure, the term link and URL are used interchangeably and refers to a web address of a unique resource on the World Wide Web (WWW). Information regarding the type of data retrieval service can include information regarding the type or, in other words, the end goal of the data retrieval service. In the current embodiment, the type or the end goal of the data retrieval service is to generate an index of a target website.

In step 203, after receiving the request for generating an index of the target website, Gateway 104 creates a task information object. As part of step 203, Gateway 104 generates a task identification (task ID) for the respective request received from Client Device 102. Task ID can include but not limited to a randomly generated 64-bit integer, increasing monotonically. The task information object created by Gateway 102 can include but is not limited to task ID, client ID, task status, start URL, index parameters, timestamps. Timestamps can refer to but are not limited to task creation timestamps and last updated timestamps. Following the creation of the task information object, in step 205, Gateway 104 sends the task information object to Central Database 112. Accordingly, in step 207, Central Database 112 receives and stores the task information object.

In step 209, Gateway 104 creates and sends a task message to Message Platform 110. The task message created and sent to Message Platform 110 can include but are not limited to task ID, index parameters, start URL. In step 211, Message Platform 110 receives and stores the task message within Message Platform's 112 internal sections. After successfully storing the task message, in step 213, Message Platform 110 reports back the successful storage of the task message to Gateway 104. It must be understood that in some implementations of the current embodiment, step 205 and step 209 can occur concurrently. That is, Gateway 104 can concurrently create and send both the task information object and task message to Central Database 112 and Message Platform 110, respectively. However, such an implementation will not affect or alter the overall functioning of the embodiment.

Consequently, in step 215, Gateway 104 sends a response message to Client Device 102, signifying the successful creation and storage of the task message. The response message sent by Gateway 104 to Client Device 102 can include but are not limited to client ID, timestamps, task ID, index parameters, start URL. Client Device 102 receives the response message from Gateway 104, and the request/response cycle between Client Device 102 and Gateway 104 is terminated. However, the connection between Client Device 102 and Gateway 104 is not necessarily terminated.

FIG. 2B is the continuation of an exemplary flow diagram showing the process for generating an index of the target website. In step 217, Link Analyzer 118 accesses and fetches the stored task message from Message Platform 110. After fetching the stored task message, in step 219, Link Analyzer 118 determines the category of the start URL. Specifically, Link Analyzer 118 determines the category of the start URL according to the index parameters. It must be recalled that the start URL and the index parameters were included in the task message. Furthermore, index parameters include information or computer programming expressions signifying the parameters for determining the category of links/URLs. The categories are indexable, indexed or excluded links. In the current embodiment, Link Analyzer 118 determines the category of the start URL as an indexable link.

In step 221, Link analyzer 118 checks for duplication. Specifically, Link Analyzer 118 checks the start URL against a list of URLs present in a duplication list. The duplication list contains URLs to web pages and/or target websites previously identified or processed by Link Analyzer 118. If the start URL matches with a URL from the duplication list, in such instances, the start URL will be considered as a duplicate link, and such duplicate links will be abandoned by Link Analyzer 118.

However, if the start URL does not match any of the URLs from the duplication list, in step 223, Link Analyzer sends the start URL to Data Extractor 120. In step 225, Data Extractor 120 receives the start URL from Link Analyzer 118 and begins the scraping process by accessing the target website (Target 126). The scraping process completes when Target 126, in step 227, sends the HTML page to Data Extractor 120. In step 229, after receiving the HTML page from Target 126, Data Extractor 120 sends the HTML page to Link Analyzer 118.

After receiving the HTML page from Data Extractor 120, in step 231, Link Analyzer 118 parses and gathers the URLs present within the HTML page. In step 233, Link analyzer 118 sends the gathered URLs to Message Platform 110 for storage. Specifically, Link Analyzer 118 sends the gathered URLs along with the respective task ID as an identity marker. Accordingly, in step 235, Message Platform 110 receives and stores the gathered URLs within an internal section of the Message Platform 110.

Subsequently, Link Analyzer 118 repeats the steps from 217 to 235. Specifically, Link Analyzer in the following steps, fetches one of the gathered URLs from Message Platform 110. After fetching one of the gathered URLs, Link Analyzer 118 determines the category of the particular gathered URL according to the index parameters. The index parameters include information or computer programming expressions signifying the parameters for determining the category of links/URLs. The categories are indexable, indexed or excluded links. Therefore, Link Analyzer 118 determines the category of the gathered URL as either an indexable or indexed or excluded link.

An excluded link (i.e., a gathered URL that is determined as an excluded link) is abandoned by Link analyzer 118. In contrast, an indexable or indexed link (i.e., a gathered URL that is determined as either an indexable or indexed link) is checked for duplication. Specifically, Link Analyzer 118 checks the indexable or indexed link against the duplication list. The indexable or indexed link that matches one of the URLs from the duplication list is considered a duplicate link. Link Analyzer 118 abandons such a duplicate link. After checking for duplication, Link Analyzer 118 sends the indexed link to Message Platform 118 for storage. Message Platform 118 receives and stores the indexed link from Link Analyzer 118 within an internal section of the Message Platform 118. However, Link Analyzer 118 sends the indexable link to Data extractor 120. Data Extractor 120 receives the indexable link and repeats the process of scraping. After scraping the indexable link, Data Extract 120 sends the HTML page of the indexed link to Link Analyzer 118. After which, Link Analyzer 118 parses and gathers URLs present within the scraped HTML page. Link analyzer 118 sends the gathered URLs to Message Platform 110 for storage. Accordingly, Message Platform 110 receives and stores the gathered URLs within an internal section of the Message Platform 110.

Thus, Link Analyzer 118 repeats the process of fetching the gathered URLs from Message Platform 110, determining the categories of the gathered URLs, checking for duplicates, sending the indexed links to Message Platform 110, and/or sending the indexable links to Data Extractor 120 for executing scraping process, parsing and gathering the URLs from the scraped HTML page and finally, sending the gathered URLs to Message Platform 110. Therefore, Link Analyzer 118 repeats the above-described processes (from step 217 to 235) till every gathered URL stored in Message Platform 110 is processed. However, in some embodiments, Link Analyzer 118 repeats the above-described processes till a specific duration of time has passed since the fetching of the task message and/or a specific number of indexed URLs are stored in Message Platform 110 and/or a specific number of parsing operation has been executed and/or a request from Client Device 102 to terminate the process. Here, one must understand that the specific duration of time, the specific number of indexed URLs, and the specific number of parsing operations are either decided by E-Commerce Toolkit Infrastructure 122 or Client Device 102.

FIG. 2C is the continuation of an exemplary flow diagram showing the process for generating an index of the target website. In step 237, Data Entry Controller 108 fetches the indexed links from Message Platform 110. In step 239, Data Entry Controller 108 sends the indexed links to Central Database 112. In step 241, Central Database 112 receives and stores the indexed links.

Subsequently, in step 243, Client Device 102 sends a request to obtain the index of the target website (Target 126). As part of the request to obtain the index of the target website (Target 126), Client Device 102 can include multiple information within the request. Some of the exemplary information included in the request to obtain the index of the target website (Target 126) are client ID, timestamps, task ID, index parameters, start URL, index format parameter. The term index parameter includes information about the necessary format in which the index of the target website (Target 126) must be provided.

After receiving the request to obtain the index of the target website (Target 126) from Client Device 102, in step 245, Gateway 104 requests Compiling Unit 114 to provide the index of the target website (Target 126). The request sent by Gateway 104 can include but is not limited to task ID, index format, client ID.

In step 247, Compiling Unit 114 fetches the indexed links from Central Database 112. Specifically, Compiling Unit 114 identifies the indexed links with the received task ID and client ID. After which, Compiling Unit 114 fetches the indexed links from Central Database 112. In step 249, Compiling Unit 114, compiles the indexed links into the necessary format specified in the index format parameter. Some exemplary formats in which Compiling Unit 114 compiles the indexed links are CSV (Comma Separated Values), JSON, JSONL, SQL database dump, and compressed collection files.

FIG. 2D is the continuation of an exemplary flow diagram showing the process for generating an index of the target website. In step 251, Compiling Unit 114 compiles and sends the compiled indexed links to Data Provider 116. In step 253, Data Provider 116 stores the compiled indexed links. In step 255, Data Provider 116 sends access information to Compiling Unit 114. The access information sent by Data Provider 116 can include links/URL for Client Device 102 to directly access and download the compiled indexed links. In step 257, Compiling Unit 114 sends the access information to Central Database 112 for storage. In step 259, Central Database 112 receives and stores the access information in the associated task information object. In step 261, Compiling Unit 114 sends the access information to Gateway 104. In step 263, Gateway 104 receives the access information from Compiling Unit 114 and sends the access information to Client Device 102. In step 265, Client Device 102 accesses the compiled indexed links stored in Data Provider 116. In step 267, Data Provider 116 provides the access to the compiled indexed links to Client Device 102. One must recall that an index of a target website is a list of indexed links/URLs that matches the index parameters provided by Client Device 102. Thus, through the above-described embodiment, Client Device 102 can request and obtain an index of a target website according to specific index parameters.

FIG. 3A is an exemplary flow diagram showing the process for generating an index of the target website and extracting data from the indexed links according to one of the embodiments. In step 301, Client Device 102 sends a request for generating an index of a target website and extracting data from indexed links. In the current embodiment the target website is represented by Target 126.

Client Device 102 can include multiple information within the request for generating an index of Target 126. Some of the exemplary information included in the request for generating an index of Target 126 are start URL, index parameters, information regarding the type of data retrieval service. Here, Start URL is the URL to the target website. Index parameters can include information or computer programming expressions signifying the parameters for determining which type of links/URLs must be identified as indexable, indexed or excluded links. For example, Client Device 102 may request to generate an index consisting of a list of links/URLs of every product page belonging to an e-commerce website. Link/URL to a product web page on a particular e-commerce website is an indexed link, whereas a link/URL to a web page that might include a link/URL to a product page is an indexable link. Other links/URLs that lead to irrelevant web pages (e.g., homepage or other non-product web pages) are excluded links. In the current disclosure, the term link and URL are used interchangeably and refers to a web address of a unique resource on the World Wide Web (WWW). Information regarding the type of data retrieval service can include information regarding the type or, in other words, the end goal of the data retrieval service. In the current embodiment, the type or the end goal of the data retrieval service is to generate an index of a target website.

In step 303, after receiving the request for generating an index of the target website, Gateway 104 creates a task information object. As part of step 303, Gateway 104 generates a task identification (task ID) for the respective request received from Client Device 102. Task ID can include but not limited to a randomly generated 64-bit integer, increasing monotonically. The task information object created by Gateway 102 can include but are not limited to task ID, client ID, task status, start URL, index parameters, timestamps. Timestamps can refer to but are not limited to task creation timestamps and last updated timestamps. Following the creation of the task information object, in step 305, Gateway 104 sends the task information object to Central Database 112. Accordingly, in step 307, Central Database 112 receives and stores the task information object.

In step 309, Gateway 104 creates and sends a task message to Message Platform 110. The task message that is created and sent to Message Platform 110 can include but is not limited to task ID, index parameters, start URL. In step 311, Message Platform 110 receives and stores the task message within Message Platform's 112 internal sections. After successfully storing the task message, in step 313, Message Platform 110 reports back the successful storage of the task message to Gateway 104.

Consequently, in step 315, Gateway 104 sends a response message to Client Device 102, signifying the successful creation and storage of the task message. The response message sent by Gateway 104 to Client Device 102 can include but are not limited to client ID, timestamps, task ID, index parameters, start URL. Client Device 102 receives the response message from Gateway 104, and the request/response cycle between Client Device 102 and Gateway 104 is terminated. However, the connection between Client Device 102 and Gateway 104 is not necessarily terminated.

FIG. 3B is the continuation of an exemplary flow diagram showing the process for generating an index of the target website. In step 317 Link Analyzer 118 accesses and fetches the stored task message from Message Platform 110. After fetching the stored task message, in step 319, Link Analyzer 118 determines the category of the start URL. Specifically, Link Analyzer 118 determines the category of the start URL according to the index parameters. It must be recalled that the start URL and the index parameters were included in the task message. Furthermore, index parameters include information or computer programming expressions signifying the parameters for determining the category of links/URLs. The categories are indexable, indexed or excluded links. In the current embodiment, Link Analyzer 118 determines the category of the start URL as an indexable link.

In step 321, Link analyzer 118 checks for duplication. Specifically, Link Analyzer 118 checks the start URL against a list of URLs present in a duplication list. The duplication list contains URLs to web pages and/or target websites previously identified or processed by Link Analyzer 118. If the start URL matches with a URL from the duplication list, in such instances, the start URL will be considered as a duplicate link, and such duplicate links will be abandoned by Link Analyzer 118.

However, if the start URL does not match any of the URLs from the duplication list, in step 323, Link Analyzer sends the start URL to Data Extractor 120. In step 325, Data Extractor 120 receives the start URL from Link Analyzer 118 and begins the scraping process by accessing the target website (Target 126). The scraping process completes when Target 126, in step 327, sends the HTML page to Data Extractor 120. In step 329, after receiving the HTML page from Target 126, Data Extractor 120 sends the HTML page to Link Analyzer 118.

After receiving the HTML page from Data Extractor 120, in step 331, Link Analyzer 118 parses and gathers the URLs present within the HTML page. In step 333, Link analyzer 118 sends the gathered URLs to Message Platform 110 for storage. Specifically, Link Analyzer 118 sends the gathered URLs along with the respective task ID as an identity marker. Accordingly, in step 335, Message Platform 110 receives and stores the gathered URLs within an internal section of the Message Platform 110.

Subsequently, Link Analyzer 118 repeats the steps from 317 to 335. Specifically, Link Analyzer in the following steps, fetches one of the gathered URLs from Message Platform 110. After fetching one of the gathered URLs, Link Analyzer 118 determines the category of the particular gathered URL according to the index parameters. The index parameters include information or computer programming expressions signifying the parameters for determining the category of links/URLs. The categories are indexable, indexed or excluded links. Therefore, Link Analyzer 118 determines the category of the gathered URL as either an indexable or indexed or excluded link.

An excluded link (i.e., a gathered URL that is determined as an excluded link) is abandoned by Link analyzer 118. In contrast, an indexable or indexed link (i.e., a gathered URL that is determined as either an indexable or indexed link) is checked for duplication. Specifically, Link Analyzer 118 checks the indexable or indexed link against the duplication list. The indexable or indexed link that matches one of the URLs from the duplication list is considered a duplicate link. Link Analyzer 118 abandons such a duplicate link. After checking for duplication, Link Analyzer 118 sends the indexed link to Message Platform 118 for storage. Message Platform 118 receives and stores the indexed link from Link Analyzer 118 within an internal section of the Message Platform 118. However, Link Analyzer 118 sends the indexable link to Data extractor 120. Data Extractor 120 receives the indexable link and repeats the process of scraping. After scraping the indexable link, Data Extract 120 sends the HTML page of the indexed link to Link Analyzer 118. After which, Link Analyzer 118 parses and gathers URLs present within the scraped HTML page. Link analyzer 118 sends the gathered URLs to Message Platform 110 for storage. Accordingly, Message Platform 110 receives and stores the gathered URLs within an internal section of the Message Platform 110.

Thus, Link Analyzer 118 repeats the process of fetching the gathered URLs from Message Platform 110, determining the categories of the gathered URLs, checking for duplicates, sending the indexed links to Message Platform 110, and/or sending the indexable links to Data Extractor 120 for executing scraping process, parsing and gathering the URLs from the scraped HTML page and finally, sending the gathered URLs to Message Platform 110. Therefore, Link Analyzer 118 repeats the above-described processes (from step 317 to 335) till every gathered URL stored in Message Platform 110 is processed.

FIG. 3C is the continuation of an exemplary flow diagram showing the process for generating an index of the target website and extracting data from the indexed links according to one of the embodiments. In step 337, Data Entry Controller 108 fetches the indexed links from Message Platform 110. In step 339, Data Entry Controller 108 sends the indexed links to Central Database 112. In step 341, Central Database 112 receives and stores the indexed links.

In step 343, Control Unit 106 sends a message to initiate the process of scraping and parsing to Message Platform 110. In step 345, Message Platform 110 receives and stores the message sent by Control Unit 106 within an internal section of the Message Platform 110. Immediately after Message Platform 110 stores the message to initiate the process of scraping and parsing, in step 347, Link Analyzer 118 fetches an indexed link from Message Platform 110. In step 349, Link Analyzer 118 sends the indexed link to Data Extractor 120.

FIG. 3D is the continuation of an exemplary flow diagram showing the process for generating an index of the target website and extracting data from the indexed links according to one of the embodiments. In step 351, Data Extractor 120 scrapes the indexed link. It must be understood that the indexed link is part of the target website (i.e., target web domain), therefore Data Extractor 120 accesses Target 126 (which is the target website) in order to scrape the indexed link. The scraping process completes when Target 126, in step 353, provides the respective HTML page to Data Extractor 120. In step 355, after receiving the HTML page from Target 126, Data Extractor 120 parses the HTML pages to extract specific data (for example, product price).

In step 357, Data Extractor 120, sends the parsed data to Link Analyzer 118. After receiving the parsed data, In step 359, Link Analyzer 118 sends the parsed data to Message Platform 110. In step 361, Message Platform 110 receives and stores the parsed data within an internal section of the Message Platform 110. Subsequently, Link Analyzer 118 repeats the steps from 347 to 359 several times till each indexed link is scraped and parsed. In step 363, Data Entry Controller 108 fetches the parsed data from Message Platform 110. In step 365, Data Entry Controller 108 sends the parsed data to Central Database 112 for storage. In step 367, Central Database 112 receives and stores the parsed data.

FIG. 3E is the continuation of an exemplary flow diagram showing the process for generating an index of the target website and extracting data from the indexed links according to one of the embodiments. Subsequently, in step 369, Client Device 102 sends a request to obtain the extracted data from indexed links. Client Device 102 can include multiple information within the above-mentioned request. Some of the exemplary information included in the request to obtain the index of the target website (Target 126) are client ID, timestamps, task ID, index parameters, start URL.

In step 371, Gateway 104 requests Compiling Unit 114 to provide the parsed data. The request sent by Gateway 104 can include but is not limited to task ID, client ID. In step 373, Compiling Unit 114 fetches the parsed data from Central Database 112. Specifically, Compiling Unit 114 identifies the parsed data with the received task ID and client ID. After which, Compiling Unit 114 fetches the parsed data from Central Database 112. In step 375, Compiling Unit 114, compiles the parsed data into the necessary format. Some exemplary formats in which Compiling Unit 114 compiles the parsed data are CSV (comma separated values), JSON, JSONL, SQL database dump, compressed collection files. In step 377, Compiling Unit 114 compiles and sends the compiled parsed data to Data Provider 116.

In step 379, Data Provider 116 stores the compiled parsed data. In step 381, Data Provider 116 sends access information to Compiling Unit 114. The access information sent by Data Provider 116 can include links/URL for Client Device 102 to directly access and download the compiled parsed data.

FIG. 3F is the continuation of an exemplary flow diagram showing the process for generating an index of the target website and extracting data from the indexed links according to one of the embodiments. In step 383, Compiling Unit 114 sends the access information to Central Database 112 for storage. In step 385, Central Database 112 receives and stores the access information in the associated task information object.

In step 387, Compiling Unit 114 sends the access information to Gateway 104. In step 389, Gateway 104 receives the access information from Compiling Unit 114 and sends the access information to Client Device 102. In step 391, Client Device 102 accesses the compiled parsed data stored in Data Provider 116. In step 393, Data Provider 116 provides the access to the compiled indexed links to Client Device 102. Thus, through the above-described embodiment, Client Device 102 can request and obtain extracted data from multiple indexed links belonging to a target website.

The embodiments herein may be combined or collocated in a variety of alternative ways due to design choice. Accordingly, the features and aspects herein are not in any way intended to be limited to any particular embodiment. Furthermore, one must be aware that the embodiments can take the form of hardware, firmware, software, and/or combinations thereof. In one embodiment, such software includes but is not limited to firmware, resident software, microcode, etc. FIG. 4 illustrates a computing system 400 in which a computer readable medium 403 may provide instruction for performing any methods and processes disclosed herein.

Furthermore, some aspects of the embodiments herein can take the form of a computer program product accessible from the computer readable medium 406 to provide program code for use by or in connection with a computer or any instruction execution system. For the purposes of this description, the computer readable medium 406 can be any apparatus that can tangibly store the program code for use by or in connection with the instruction execution system, apparatus, or device, including the computing system 400.

The computer readable medium 406 can be any tangible electronic, magnetic, optical, electromagnetic, infrared, or semiconductor system (or apparatus or device). Some examples of a computer readable medium 406 include solid state memories, magnetic tapes, removable computer diskettes, random access memories (RAM), read-only memories (ROM), magnetic disks, and optical disks. Some examples of optical disks include read only compact disks (CD-ROM), read/write compact disks (CD-R/W), and digital versatile disks (DVD).

The computing system 400 can include one or more processors 402 coupled directly or indirectly to memory 408 through a system bus 410. The memory 408 can include local memory employed during actual execution of the program code, bulk storage, and/or cache memories, which provide temporary storage of at least some of the program code in order to reduce the number of times the code is retrieved from bulk storage during execution.

Input/output (I/O) devices 404 (including but not limited to keyboards, displays, pointing devices, I/O interfaces, etc.) can be coupled to the computing system 400 either directly or through intervening I/O controllers. Network adapters may also be coupled to the computing system 400 to enable the computing system 400 to couple to other data processing systems, such as through host systems interfaces 412, printers, and/or storage devices through intervening private or public networks. Modems, cable modems, and Ethernet cards are just examples of network adapter types.

Identifiers, such as “(a),” “(b),” “(i),” “(ii),” etc., are sometimes used for different elements or steps. These identifiers are used for clarity and do not necessarily designate an order for the elements or steps.

Although several embodiments have been described, one of ordinary skill in the art will appreciate that various modifications and changes can be made without departing from the scope of the embodiments detailed herein. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as a critical, required, or essential feature or element of any or all the claims. The invention is defined solely by the appended claims including any amendments made during the pendency of this application and all equivalents of those claims as issued.

Moreover, in this document, relational terms such as first and second, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without additional constraints, preclude the existence of additional identical elements in the process, method, article, and/or apparatus that comprises, has, includes, and/or contains the element. The terms “a” and “an” are defined as one or more unless explicitly stated otherwise herein. The terms “approximately”, “about” or any other version thereof, are defined as being close to as understood by one of ordinary skilled in the art. A device or structure that is “configured” in a certain way is configured in at least that way but may also be configured in ways that are not listed. For the indication of elements, a singular or plural form can be used, but it does not limit the scope of the disclosure and the same teaching can apply to multiple objects, even if in the current application an object is referred to in its singular form.

The Disclosure is provided to allow the reader to quickly ascertain the nature of the technical disclosure. It is submitted with the understanding that it will not be used to interpret or limit the scope or meaning of the claims. In addition, in the foregoing Detailed Description, it is demonstrated that multiple features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment.

The disclosure presents a method of producing an index of a website, comprising:

(a) fetching a task message including index parameters and a URL for the web site;

(b) determining a category of the URL present within the task message, according to the index parameters, the category specifying whether a web page addressed by the URL is to be fetched for indexing;

when the category specifies that the web page addressed by the URL is to be fetched for indexing:

(c) accessing the web page addressed by the URL;

(d) receiving a content from the web page addressed by the URL;

(e) parsing the content to gather URLs present within the content;

(f) based on the index parameters, identifying which of the URLs gathered in (e) are to be indexed; and

(g) storing the URLs identified in (f) in the index for the website.

The method is presented wherein information is extracted from the content contained in the website pointed to by the indexed URLs, the method further comprising, for respective URLs stored in the index of the website:

(h) accessing a target web page addressed by a respective URL;

(i) receiving a content from the target web page accessed in (h);

(j) parsing the content received in (i) to extract data;

(k) compiling the data extracted in (j) into a format requested by a client device; and

(l) providing the client device with access information to the compiled extracted data.

The method is presented, wherein the access includes links or URLs to access and download the compiled extracted data.

The method is presented further comprising, for a request cycle with a client device:

receiving a specification for the index from the client device;

creating the task message based on the received specification;

sending a response message to the client device, the response message signifying the successful creation and storage of the task message; and

terminating the request cycle with the client device.

The method further comprising recursively repeating steps (b)-(g) for each URL gathered in (e).

The method is presented wherein the recursive repeating of steps (b)-(g) occurs until every URL gathered in (e) has been accessed or at least when any or combination of the following criteria occur:

a particular amount of time set internally or by a client has passed since the start of the accessing (c), the receiving (d), the parsing (e), or the storing (g), or any combination of the mentioned actions,

(ii) a number of URLs in the index has reached a threshold set internally or by the client,

(iii) a number of accessing (c) operations has reached a threshold set internally or by the client, or

(iv) a number of parsing (e) operations has reached a threshold set internally or by the client.

The disclosed method is presented wherein any of the time in (i) or thresholds in (ii)-(iv) are configured to be overridden by the client device.

The method is presented further comprising checking each URL gathered in (e) against a duplication list, wherein steps (c)-(g) are repeated only when the respective URL is determined not to be in the duplication list.

The disclosed method wherein the duplication list contains URLs to target websites previously identified or processed.

The method is presented wherein the task message includes, any of the following but not limited to: task ID, client ID, task status, start URL, the index parameters, timestamps.

The disclosed method is presented wherein the URL is the URL to the target website.

The disclosed method is presented wherein the content is stored in a cache.

The method is presented further comprising:

compiling the index into a format requested by the client device; and the client device is provided with access information to the compiled indexed URLs.

The method of claim 1, wherein the category of the URL present within the task message can be one of the following:

indexed URL, where the URL leads to the content requested in the task message;

indexable URL, where the URL is a link to a web page that might contain a URL to the content requested in the task message; and

excluded URL, where the URL leads to any other link or URL to irrelevant web pages.

The disclosed method is presented wherein the index parameters include information or computer programming expressions signifying whether URLs must be identified as indexable, indexed, or excluded.

The disclosed method is presented wherein the index is a list of indexed URLs that matches the index parameters.

A disclosure further presents a non-transitory computer-readable device having instructions stored thereon that, when executed by at least one computing device, cause the at least one computing device to perform operations producing an index of a website, the operations comprising:

(a) fetching a task message including index parameters and a URL for the web site;

(b) determining a category of the URL present within the task message, according to the index parameters, the category specifying whether a web page addressed by the URL is to be fetched for indexing;

wherein when the category specifies that the web page addressed by the URL is to be fetched for indexing:

(c) accessing the web page addressed by the URL;

(d) receiving a content from the web page addressed by the URL;

(e) parsing the content to gather URLs present within the content;

(f) based on the index parameters, identifying which of the URLs gathered in (e) are to be indexed; and

(g) storing the URLs identified in (f) in the index of the website.

The disclosed non-transitory computer-readable device is presented, wherein the operations further comprising recursively repeating steps (b)-(g) for each URL gathered in (e).

The non-transitory computer-readable device disclosed above is presented, wherein the recursive repeating of steps (b)-(g) occurs until every URL gathered in (e) has been accessed or at least when any or combination of the following criteria occur:

a particular amount of time set internally or by a client has passed since the start of the accessing (c), the receiving (d), the parsing (e), or the storing (g), or any combination of the mentioned actions,

(ii) a number of URLs in the index has reached a threshold set internally or by the client,

(iii) a number of accessing (c) operations has reached a threshold set internally or by the client, or

(iv) a number of parsing (e) operations has reached a threshold set internally or by the client.

The disclosure further presents a system for producing an index of a website, comprising:

at least one processor;

a memory coupled to the at least one processor;

a link analyzer configured to fetch a task message including index parameters and a URL for the website and determine a category of the URL present within the task message, according to the index parameters, the category specifying whether a web page addressed by the URL is to be fetched for indexing; and

a data extractor configured to, when the category specifies that the web page addressed by the URL is to be fetched for indexing, access the web page addressed by the URL, receive a content from the web page addressed by the URL, and parse the content to gather URLs present within the content,

wherein the link analyzer is further configured to, based on the index parameters, identify which of the URLs gathered by the data extractor are to be indexed and store the URLs identified in (f) in the index of the website.

1. A method of producing an index of a website, comprising:
(a) fetching a task message including index parameters and a URL for the web site;
(b) determining a category of the URL present within the task message, according to the index parameters, the category specifying whether a web page addressed by the URL is to be fetched for indexing;
when the category specifies that the web page addressed by the URL is to be fetched for indexing:
(c) accessing the web page addressed by the URL;
(d) receiving a content from the web page addressed by the URL;
(e) parsing the content to gather URLs present within the content;
based on the index parameters, identifying which of the URLs gathered in (e) are to be indexed; and
(g) storing the URLs identified in (f) in the index for the website.

2. The method of claim 1, wherein information is extracted from the content contained in the website pointed to by the indexed URLs, the method further comprising, for respective URLs stored in the index of the website:
(h) accessing a target web page addressed by a respective URL;
(i) receiving a content from the target web page accessed in (h);
(j) parsing the content received in (i) to extract data;
(k) compiling the data extracted in (j) into a format requested by a client device; and
(l) providing the client device with access information to the compiled extracted data.

3. The method according to claim 2, wherein the access includes links or URLs to access and download the compiled extracted data.

4. The method of claim 1, further comprising, for a request cycle with a client device:
receiving a specification for the index from the client device;
creating the task message based on the received specification;
sending a response message to the client device, the response message signifying the successful creation and storage of the task message; and
terminating the request cycle with the client device.

5. The method of claim 1, further comprising recursively repeating steps (b)-(g) for each URL gathered in (e).

6. The method of claim 5, wherein the recursive repeating of steps (b)-(g) occurs until every URL gathered in (e) has been accessed or at least when any or combination of the following criteria occur:
(i) a particular amount of time set internally or by a client has passed since the start of the accessing (c), the receiving (d), the parsing (e), or the storing (g), or any combination of the mentioned actions,
(ii) a number of URLs in the index has reached a threshold set internally or by the client,
(iii) a number of accessing (c) operations has reached a threshold set internally or by the client, or
(iv) a number of parsing (e) operations has reached a threshold set internally or by the client.

7. The method of claim 6, wherein any of the time in (i) or thresholds in (ii)-(iv) are configured to be overridden by the client device.

8. The method of claim 5, further comprising checking each URL gathered in (e) against a duplication list, wherein steps (c)-(g) are repeated only when the respective URL is determined not to be in the duplication list.

9. The method of claim 8, wherein the duplication list contains URLs to target websites previously identified or processed.

10. The method of claim 1, wherein the task message includes, any of the following but not limited to: task ID, client ID, task status, start URL, the index parameters, and timestamps.

11. The method of claim 1, wherein the URL is the URL to the target website.

12. The method of claim 1, wherein the content is stored in a cache.

13. The method of claim 1, further comprising:
compiling the index into a format requested by the client device; and the client device is provided with access information to the compiled indexed URLs.

14. The method of claim 1, wherein the category of the URL present within the task message can be one of the following:
indexed URL, where the URL leads to the content requested in the task message;
indexable URL, where the URL is a link to a web page that might contain a URL to the content requested in the task message; and
excluded URL, where the URL leads to any other link or URL to irrelevant web pages.

15. The method of claim 14, wherein the index parameters include information or computer programming expressions signifying whether URLs must be identified as indexable, indexed, or excluded.

16. The method of claim 1, wherein the index is a list of indexed URLs that matches the index parameters.

17. A non-transitory computer-readable device having instructions stored thereon that, when executed by at least one computing device, cause the at least one computing device to perform operations producing an index of a website, the operations comprising:
(a) fetching a task message including index parameters and a URL for the web site;
(b) determining a category of the URL present within the task message, according to the index parameters, the category specifying whether a web page addressed by the URL is to be fetched for indexing;
wherein when the category specifies that the web page addressed by the URL is to be fetched for indexing:
(c) accessing the web page addressed by the URL;
(d) receiving a content from the web page addressed by the URL;
(e) parsing the content to gather URLs present within the content;
based on the index parameters, identifying which of the URLs gathered in (e) are to be indexed; and
(g) storing the URLs identified in (f) in the index of the website.

18. The non-transitory computer-readable device of claim 17, the operations further comprising recursively repeating steps (b)-(g) for each URL gathered in (e).

19. The non-transitory computer-readable device of claim 18, wherein the recursive repeating of steps (b)-(g) occurs until every URL gathered in (e) has been accessed or at least when any or combination of the following criteria occur:
(i) a particular amount of time set internally or by a client has passed since the start of the accessing (c), the receiving (d), the parsing (e), or the storing (g), or any combination of the mentioned actions,
(ii) a number of URLs in the index has reached a threshold set internally or by the client,
(iii) a number of accessing (c) operations has reached a threshold set internally or by the client, or
(iv) a number of parsing (e) operations has reached a threshold set internally or by the client.

20. A system for producing an index of a website, comprising:
at least one processor;
a memory coupled to the at least one processor;
a link analyzer configured to fetch a task message including index parameters and a URL for the website and determine a category of the URL present within the task message, according to the index parameters, the category specifying whether a web page addressed by the URL is to be fetched for indexing; and
a data extractor configured to, when the category specifies that the web page addressed by the URL is to be fetched for indexing, access the web page addressed by the URL, receive a content from the web page addressed by the URL, and parse the content to gather URLs present within the content,
wherein the link analyzer is further configured to, based on the index parameters, identify which of the URLs gathered by the data extractor are to be indexed and store the URLs identified by the link analyzer in the index of the website.
